(19) United States
(12) Patent Application Publication
(10) Pub. No.: US 2023/0071363 A1
(43) Pub. Date: Mar. 9, 2023

(54) FLATULATING AQUARIUM DECORATION

(71) Applicant: Joseph S. Sporn, New York, NY (US)

(72) Inventor: Joseph S. Sporn, New York, NY (US)

(21) Appl. No.: 17/468,854

(22) Filed: Sep. 8, 2021

(51) Int. Cl. A01K 63/00

(52) U.S. Cl. CPC A01K 63/006

(57) ABSTRACT

A bubbler decoration for an aquarium comprising a model of a human figure having an air intake port connected by tubing to an air pump, an air outlet port in the gluteal region of the model and an interior air passage interconnecting the intake and outlet ports.

The present invention involves a novelty decoration intended for use in an aquarium or similar water feature.

### BACKGROUND

Aquarium decorations can be found in an infinite number of static forms such as castles, ship wrecks and other ornaments. Interactive bubblers that emit constant or intermittent flows of air bubbles have the dual purpose of supplying oxygen to the tank water and also creating a dynamic and vibrant quality to the aquarium decoration. The bubbler ornament of the present invention has, as its objective, to fulfill the advantages and benefits of traditional bubbler ornaments but to also add a humorous touch to the ornamentation of an aquarium or similar water feature.

### SUMMARY OF THE INVENTION

The aquarium bubbler of the present invention includes a model of a human figure engaging in an underwater task related to a buried treasure chest. In the preferred embodiment the figure is bent over at the waist to make the gluteal region of the figure prominent. Air from a source outside of the aquarium is either continuously or intermittently pumped into an air passage within the human figure model which air passage has an outlet port disposed in the gluteal region of the diver figure.

### DESCRIPTION OF THE DRAWINGS

FIG. 1 is a perspective view of a model of a human figure in a deep sea diving outfit, comprising the ornamental aquarium bubbler of the present invention, including a manual air pump and the tubing interconnecting the pump with the figure.

FIG. 2 is a side view of the model of a human figure disposed as an ornamental bubbler in an aquarium.

FIG. 3 is a diagrammatic side view of the human figure model.

### DETAILED DESCRIPTION OF THE PREFERRED EMBODIMENT

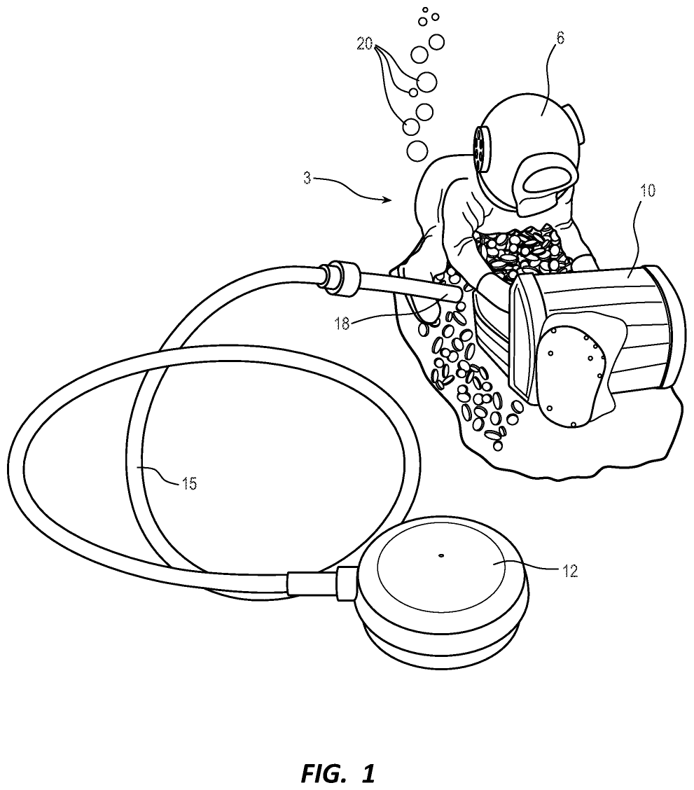

FIG. 1 illustrates a model of a human deep sea diver 3 wearing a diving helmet 6 and bent over a treasure chest 10. The balloon 12 of a manually operated air pump is shown connected to flexible tubing 15 that conveys pressurized air to an intake port 18 in the body of the diver 3. Figurative air bubbles 20 are seen emanating from the posterior of the diver 3. While the manual air pump 12 with intermittent air flows is preferred, the manual pump can be replaced with or alternated with a conventional electrically driven air pump to produce continually flowing air bubbles 20.

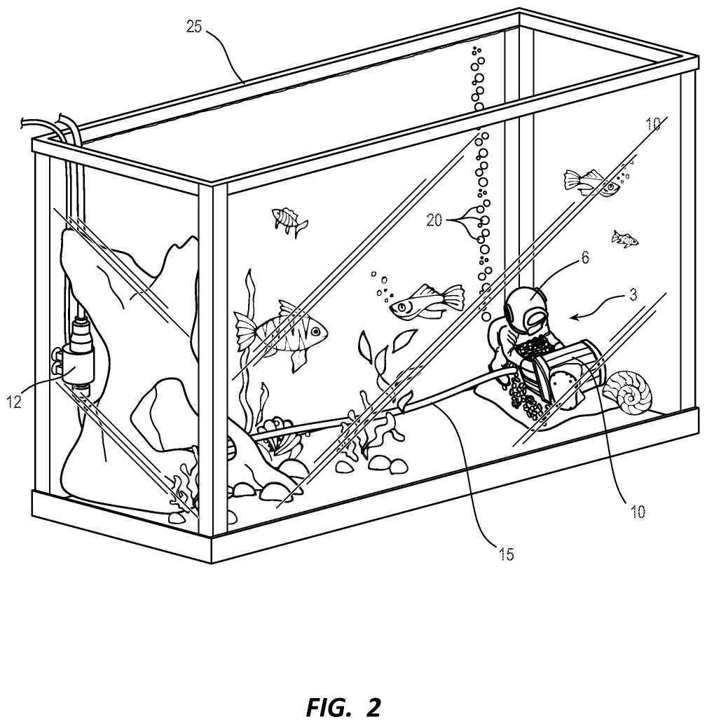

FIG. 2 shows the diver 3 disposed in an aquarium 25 with the air pump 12 positioned exteriorly of the aquarium. Flexible air transport tubing 15 runs from the output of the air pump 12 into the aquarium where it is connected to the air intake port 18 of the diver 3.

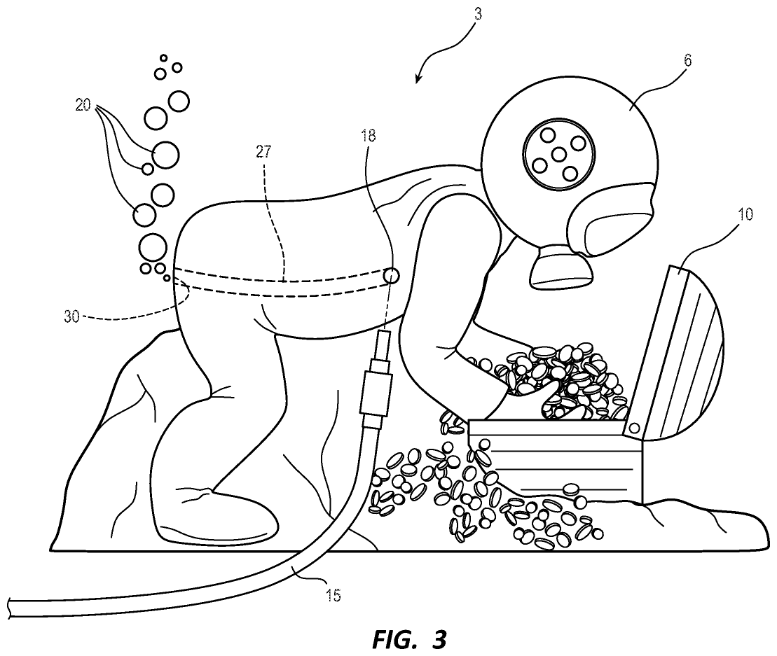

The diagrammatic showing of the diver 3 in FIG. 3 illustrates the interior air passage 27 that interconnects the air intake port 18 in the body of the diver 3 with the air exhaust port 30 in the gluteal region of the diver.

In operation, the flow of air out of the exhaust port 30 in the gluteal region of the diver 3 and the resultant bubbles 20 rising to the surface of the aquarium water simulates the occasional or continuous fluctuation of the diver 3, all to the amusement of those observing the aquatic activities in the aquarium.

I claim:

1. A novelty decoration for an aquarium comprising,
a model of a human figure bent over an object and having,
an air intake port,
an air outlet port,
an interior air passage interconnecting the intake and outlet ports,
an air pump having an output,
flexible tubing interconnecting the air pump output and the intake port.

2. The aquarium decoration of claim 1 where the model of a human figure includes the gluteal region and the air outlet port is disposed in the gluteal region of the model.

3. The aquarium decoration of claim 2 where the air pump comprises a hand operated balloon.
